(19) United States
(12) Patent Application Publication
(10) Pub. No.: US 2006/0103639 A1
(43) Pub. Date: May 18, 2006

(54) Display device

(75) Inventor: Tsuyoshi Ichiraku, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD

(21) Appl. No.: 11/272,742

(22) Filed: Nov. 15, 2005

(30) Foreign Application Priority Data
Nov. 16, 2004 (JP) 2004-332500

(51) Int. Cl. G09G 5/00

(52) U.S. Cl. 345/204

(57) ABSTRACT

A display device is provided which is capable of, at time of driving a display panel section, preventing noise caused by components exhibiting a piezoelectric effect and of achieving silent operations and removal of unpleasant audible noise. When load variation for each line has an audio frequency component, noise occurs in components exhibiting a piezoelectric effect such as a capacitor. A load variation detecting unit totalizes input display data for every line and, when it is estimated from an amount of variation of the values and variation period that an amount of variation of driving load is large and a variation period is within an audio frequency range, produces a display pattern representing a variation period and instructs a driver controlling unit to permute order of driving lines. The driver controlling unit searches a table for a pattern to be used and changes the variation period to be out of the audio frequency range to prevent occurrence of audible noise.

### BACKGROUND OF THE INVENTION

1. Field of the Invention

The present invention relates to a display device to show a desired video or information by driving a display panel section and more particularly to the display device capable of preventing noise caused by components exhibiting a piezoelectric effect and by driving the display panel section and of realizing silent operations and removal of unpleasant audible noise.

The present application claims priority of Japanese Patent Application No. 2004-332500 filed on Nov. 16, 2004, which is hereby incorporated by reference.

2. Description of the Related Art

In recent years, as a display device to be employed for televisions, monitor displays, or a like is becoming large in size, maximum power required for driving a display panel section used in the display device is increasing. The required power differs depending on a display pattern, and a difference in the required power among display patterns is becoming large. In the case of components exhibiting a piezoelectric effect such as a capacitor used in a driving circuit of the display device, since the difference in the required power appears as a voltage ripple, the larger the ripple amount becomes, the larger the vibration amount becomes and, therefore, if its vibration period is within a range of an audio frequency, the possibility that the vibration is recognized as audible noise, increases.

For an explanation thereof, electrical configurations and operational examples of a conventional display device will be described below. FIG. 9 is a block diagram showing one example of electrical configurations of a conventional display device. The display device used in the conventional example is a display panel section using a liquid crystal or a like. The display device, as shown in FIG. 9, includes a display panel section 1 to display a video and/or information input as display data, a source driver 2 and gate driver 3 both being used to drive the display panel section 1, a controlling section 12 having, at least, a driver controlling section 11. The driver controlling section 11 outputs data corresponding to a line (scanning line) to be driven first to the source driver 2. Normally, the data is display data input in a serial format which is output, as it is, in a serial format manner. In some cases, sorting of input display data is required to meet conditions of a driving method employed in the display panel section 1. In this case, the input display data is stored, on a temporary basis, in a memory section 13 and is sorted therein and is then input to the driver controlling section 11. The driver controlling section 11 outputs a start pulse (VSP) at a leading line of a frame to the gate driver 3 and causes the start pulse (VSP) to be shifted by output of a plurality of continuous shift clocks (VCK) and exercises control so that source data is output to lines (01, 02, 03 . . . ) to be driven. At this point time, masking is performed so that the source data is not output while the driving lines are being shifted and an output enable signal (VOE) is output so that the source data is output when specified lines are driven after termination of the shifting. Also, the driver controlling section 11, when polarity control on a driving voltage is required as in the case of a liquid crystal display panel section, a voltage polarity controlling signal (PC) is output to the source driver 2 in a manner to correspond to lines to be driven. As described above, a display panel section 1 is driven for every one line and, therefore, load variations depending on luminance of each line occur at a driving timing for every one line, which produces voltage ripples, thus causing components exhibiting a piezoelectric effect to vibrate.

Next, operations of the conventional display device are explained. In a display device in which, the lower the luminance is, the smaller the driving load is and the higher the luminance is, the larger the driving load is; it is here assumed that a driving horizontal frequency is 65 kHz.

First, if each line is driven according to a display pattern in which a white and a black produced by a change in luminance appear repeatedly in each line, a load variation frequency is obtained in every one line so that the pattern is displayed in order of “white, black, white, black, . . . ” and, therefore, ripples as shown in FIG. 10 occur in a driving circuit. A load variation frequency C obtained at this time point is 33 kHz which is out of the audio frequency range and, therefore, vibration of components exhibiting a piezoelectric effect caused by the ripples is not recognized as audible noise. Next, if each line is driven according to a display pattern in which a white and a black appear repeatedly in every two lines, the pattern is displayed in order of “white, white, black, black, white, white, black, black, . . . ” and variations in load occur in every two lines and ripples as shown in FIG. 11 occur in the driving circuit. A load variation frequency D obtained at this time point is 16.25 kHz which is within the audio frequency range and, therefore, vibration of components exhibiting a piezoelectric effect caused by the ripples is recognized as audible noise. As described above, in a display panel section to be driven for every line, load variations occur depending on a period of horizontal synchronization and vibration period in which the vibration is recognized as audible noise varies depending on timing of driving a display panel section.

Conventional technology to suppress noise occurring in a display device is disclosed in Japanese Patent Application Laid-open No. 2000-349360 (Patent reference 1) in which a connecting conductor is connected to a connecting portion of a piezoelectric transformer with an vibration-absorbing section interposed between the connecting conductor and connecting portion of the piezoelectric transformer in order to prevent occurrence of audible noise of the connecting conductor caused by an vibration frequency of the piezoelectric transformer used in a liquid crystal display panel section or a like.

Another conventional technology is disclosed in Japanese Patent Application Laid-open No. 2004-086147 (Patent reference 2) in which, in order to reduce a low-frequency sound occurring from a surface of a liquid crystal display panel section caused by a piezoelectric phenomenon of a liquid crystal, based on the assumption that the low-frequency sound occurs when one of a bipolar voltage of a facing electrode increases in one vertical period, by reversing the polarity of a driving signal of the facing electrode in every one horizontal period (line) and, when a period of one polarity is longer than that of another polarity in one vertical period, by reversing the polarity occurring in the longer period on arbitrary timing, an effective bipolar voltage of the facing electrode is made equal in one vertical period.

Still another conventional technology is disclosed in Japanese Patent Application Laid-open No. Hei11-133424 (Patent reference 3) in which, in order to reduce audible noise occurring in an EL (Electroluminescence) light-emitting element, in the EL light-emitting element made up of a front electrode (electrode mounted on a side of a liquid crystal panel) and a rear electrode with an EL layer being sandwiched between the both electrodes, a solid-fill shaped copper foil is formed on a facing surface of a printed board placed on a side of the rear electrode with an electrical insulating layer interposed between the rear electrode and printed board and, by connecting the formed copper foil to the front electrode, an alternating voltage being in phase with that of the front electrode is applied.

However, the conventional technologies have problems. As a display device is becoming larger in size, an amount of load variation occurring at time of driving a display panel section increases and, as a result, a possibility increases that noise produced by components exhibiting a piezoelectric effect employed in the display device becomes a problem. That is, in recent years, due to the widespread use of flat devices, large-sized flat display devices are being used in very silent environments such as an art museum, hospital, or a like, where silent operations and removal of unpleasant audible noise are required on all conditions. When a large-sized display device is introduced in such environments, there is a fear that a display device that produces noise occurring in components exhibiting a piezoelectric effect becomes unfit for use therein.

Moreover, the piezoelectric transformer disclosed in the Patent reference 1 is so configured as to vibrate a vibration plate using a driving signal on a primary side and to take a voltage on a secondary side induced by the vibration and, therefore, the noise occurring in the piezoelectric transformer is different from that occurring due to load variations caused by a display pattern which is to be overcome by the present invention. Also, in the technology disclosed in the Patent reference 2, it is presumed that the low-frequency sound produced from the surface of the liquid crystal panel occurs when one of the bipolar voltage of a facing electrode in one vertical period increases and, therefore, the produced low-frequency sound is different from the noise occurring due to load variations caused by a display pattern. Similarly, the audible noise occurring in the EL light-emitting element disclosed in the Patent reference 3 is a noise produced by an alternating voltage to be applied to the front and rear electrodes to make the EL layer emit light and, therefore, the noise is different from that occurring due to load variations caused by a display pattern in the present invention. That is, the conventional technologies described above cannot prevent noise occurring in components exhibiting a piezoelectric effect due to load variation caused by a display pattern.

### SUMMARY OF THE INVENTION

In view of the above, it is an object of the present invention to provide a display device which is capable of, at time of driving display panel section, preventing occurrence of audible noise from components exhibiting a piezoelectric effect due to a variation period of load variations caused by a display pattern and of achieving silent operations and removal of unpleasant audible noise.

According to a first aspect of the present invention, there is provided a display device including:

a display panel section having a plurality of scanning lines;

a driver to drive the display panel section for every scanning line;

at least one piezoelectric component exhibiting a piezoelectric effect;

a detecting unit to detect, predict or estimate directly or indirectly a variation period and timing of occurrence of a first load variation causing occurrence of audible noise from the at least one piezoelectric component; and

a driver controlling unit to output a control signal to the driver, the control signal used to permute order of driving the plurality of the scanning lines for another order of driving the plurality of the scanning lines which gives a variation period of a second load variation that prevents occurrence of audible noise caused by the at least one piezoelectric component, according to the detected, the predicted or the estimated variation period of the first load variation.

In the foregoing, a preferable mode is one wherein the detecting unit totalizes input display data for every the scanning line, and detects, predicts or estimates directly or indirectly the variation period and the timing of occurrence of the first load variation, based on a variation amount and the variation period of the total value of the input display data for every the scanning line.

Also, a preferable mode is one wherein the detecting unit detects the audible noise caused by the at least one piezoelectric component, and detects, predicts or estimates directly or indirectly the variation period and the timing of occurrence of the first load variation, based on the detected audible noise.

Also, a preferable mode is one wherein the detecting unit measures an amount of load variation and a variation period, and detects, predicts or estimates directly or indirectly the variation period and the timing of occurrence of the first load variation, based on the measured amount of the load variation and the measured variation period.

Also, a preferable mode is one wherein the detecting unit detects binary luminance values as the input display data for every the scanning line.

Also, a preferable mode is one wherein the detecting unit detects a display pattern made up of binary luminance values, the variation period of the first load variation represented by the display pattern made up of binary luminance values.

Also, a preferable mode is one wherein the detecting unit detects an individual line number of a scanning line associated with the input display data, the timing of occurrence of the first load variation represented by the detected line number.

Also, a preferable mode is one wherein the detecting unit detects or calculates a count of the scanning lines, the variation period of the first load variation represented by the detected or calculated count of the scanning lines.

Also, a preferable mode is one wherein the driver controlling unit calculates the count of the scanning lines based on the variation period of the first load variation detected, predicts or estimates directly or indirectly by the detecting unit.

Also, a preferable mode is one wherein the driver controlling unit has a table storing, in advance, driving order patterns for permuting the scanning lines, corresponding to the variation period of the first load variation.

In addition, a preferable mode is one wherein the driver controlling unit searches the table based on the detected, the predicted or the estimated variation period of the first load variation, and as a result of the search, permutes order of driving the plurality of the scanning lines for another order of driving the plurality of the scanning lines which provides the variation period of the second load variation that prevents occurrence of audible noise caused by the at least one piezoelectric component.

Another preferable mode is one wherein the driver has a shift register being able to shift driving order of the scanning lines forward or backward, and wherein the driver controlling unit outputs a first control signal to perform masking of an output of display data according to order of driving the scanning lines and a second control signal to indicate to shift driving order of the scanning lines forward or backward.

Still another preferable mode is one wherein the driver controlling unit permutes order of driving the scanning lines according to order of driving the scanning lines by using a memory section capable of storing the input display data for the plurality of the scanning lines.

With the above configuration, when the load variations that vary depending on a display pattern of display data to be input are large and when a load variation frequency is within an audio frequency range, displaying free from occurrence of audible noise in all load variations depending on a display pattern can be achieved by permuting order of driving lines to cause a frequency of piezoelectric vibration to be outside of an audio frequency range so as to prevent audible noise occurring due to a piezoelectric effect exhibited by components such as a capacitor.

With another configuration, prevention of audible noise caused by components exhibiting a piezoelectric effect can be achieved by exercising control of frequency components in the audible noise phenomenon by permuting order of driving lines without taking a measure to reduce a load of each pixel that may affect an image quality and without using components exhibiting no piezoelectric effect that may present a problem in terms of a mounting area and/or costs.

With still another configuration, a memory section mounted to sort input display data according to a method of driving a display panel section or a frame memory mounted to improve a display characteristic such as a moving-image characteristic can be also used as a memory section to change a driving scanning line, which can reduce costs further.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing electrical configurations of a display according to a first embodiment of the present invention;

FIG. 2 is a diagram showing timing of a control signal to be fed from a driver controlling section to each driver and of a control signal fed from a driver to a display panel occurring when order of driving lines is permuted in the display of FIG. 1;

FIG. 3 is a diagram showing timing of a control signal to be fed from the driver controlling section to each driver and of a control signal fed from the driver to the display panel occurring when lines are driven in an ordinary driving order in the display of FIG. 1;

FIG. 4 is a diagram showing a frequency of load variations being out of an audio frequency range when lines are driven in the display of FIG. 1;

FIG. 5 is a diagram showing load variations being within the audio frequency range that causes noise from components exhibiting a piezoelectric effect when lines are driven in the display of FIG. 1;

FIG. 6 is a diagram showing one example of permuting order of driving lines in the display of FIG. 1;

FIG. 7 is a diagram showing another example of permuting order of driving lines in the display of FIG. 1;

FIG. 8 is a block diagram showing electrical configurations of a display of second and third embodiments of the present invention;

FIG. 9 is a block diagram showing one example of electrical configurations of a conventional display;

FIG. 10 is a diagram showing a frequency of load variations being out of an audio frequency range when lines are driven in the display of FIG. 9; and

FIG. 11 is a diagram showing load variations being within the audio frequency range that causes noise from components exhibiting a piezoelectric effect when lines are driven in the display of FIG. 9.

### DETAILED DESCRIPTION OF THE PREFERRED EMBODIMENTS

Best modes of carrying out the present invention will be described in further detail using various embodiments with reference to the accompanying drawings.

In a display device of the present invention, a purpose of preventing noise caused by components exhibiting a piezoelectric effect and realizing silent operations and removal of unpleasant audible noise is achieved, when a driving load variation that varies depending on a display pattern periodically for every several lines has a component of an audio frequency, by estimating or detecting audible noise occurring in the components exhibiting a piezoelectric effect such as a capacitor or a like and by permuting the order of the driving lines. That is, when an amount of variation in driving load is large and its variation frequency is within an audio frequency range, by permuting order of driving lines to make the variation frequency be outside of the audio frequency range, occurrence of audible noise is avoided. Since the variation frequency differs depending on a pattern of display data, a plurality of patterns to be used for making the variation frequency be outside of the audio frequency range is prepared and selection is made out of the patterns according to a thing that represents the detected, predicted or estimated variation frequency. The number of a start line is detected as a thing that represents timing for permuting order of driving lines at time of detecting a variation period or the timing is determined based on the number of the line to be driven or a like by considering a difference in driving timing. Moreover, though the audio frequency is 20 kHz to 20 Hz, order changing patterns are prepared in a range where occurrence of audible noise in circuit components or a like is anticipated.

To judge whether order of driving lines should be permuted, following three methods are available.

(1) Judgement is made from an amount of variation in values obtained by totalizing input display data for every line and from a frequency of the variation.

(2) Judgement is made from a result from detection of actual noise using a sensor.

(3) Judgement is made from an amount of variation in loads detected from voltage ripples or a like and from a frequency of the variation.

Moreover, permuting of driving order is made for every frame since noise is recognized only when same display patterns appear during several frames. Also, a display pattern displayed during a present frame is very analogous to that displayed during a subsequent frame and, therefore, permuting of driving order that has been judged during the present frame is made also during the subsequent frame. The permuting of driving order is made by using a memory section to store data of the number of lines for each line, a line driving IC (Integrated Circuit) (gate driver) that can be shifted in both directions and have a function of controlling an output, and a controlling circuit (driver controlling section) to control the memory section and line driving IC (control of shifting direction, clock, and output enable signal (VOE)). Capacity being able to store, at least, data of the maximum number of lines corresponding to prepared display patterns to be used for permuting the order of the driving lines is required as capacity of the memory section.

### First Embodiment

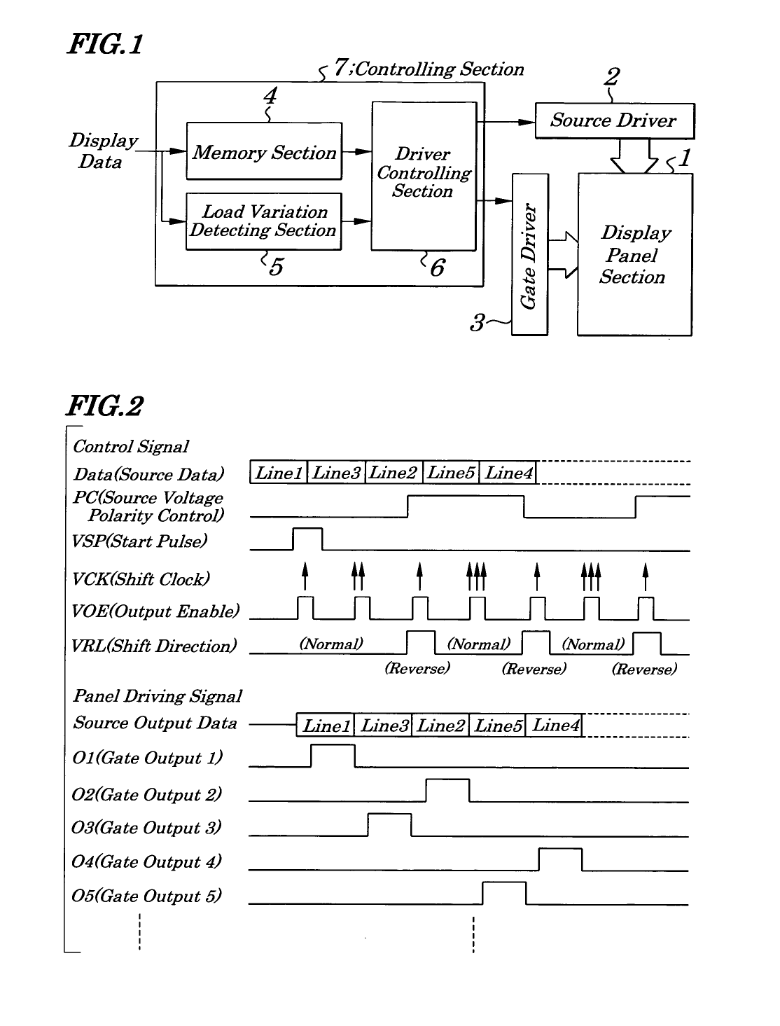

A first embodiment of the present invention will be described. The first embodiment is carried out according to a method (1) described above. FIG. 1 shows configurations of a display device according to the first embodiment. The display (liquid crystal display device) of the first embodiment includes a display panel section (liquid crystal display panel section) 1, a source driver 2 and gate driver 3 both being used to drive the display panel section 1 and a controlling section having a memory section 4, a load variation detecting section 5 and a driver controlling section 6. The display device of the first embodiment is made up of, in addition to components of a conventional display device shown as one example in FIG. 9, a controlling section 7 which has the memory section 4 with capacity corresponding to the number of lines required for temporarily storing data when order of driving display data is permuted and the load variation detecting section 5 used to judge whether or not the driving order is permuted. The driver controlling section 6 has the function of outputting a control signal to drive the display panel section 1 with driving lines being changed, to the gate driver 3. Moreover, the conventional display device shown in FIG. 9 has a memory to be used when sorting of data is required for transferring data to the source driver 2 according to some methods for driving a liquid crystal display panel section, a frame memory to be used when the function of correcting degradation in image quality caused by overshooting driving or a like is to be provided, or a like and, therefore, these memories can be also employed, in a shared manner, in the display device of the present invention.

The load variation detecting section 5 employs a method for estimating an amount of load variation and its variation period from input display data. That is, a sum total of pixel data is calculated on each line of input display data to obtain an amount of load occurring on every driving line. Each pixel data represents a luminance value of each color out of RGB (Red, Green, and Blue) colors and, therefore, a sum total of the pixel data for every line is a total value of luminance for every line, which is a value representing a load of a line. When the value obtained by the above calculation exceeds a predetermined high load value that may cause noise, counting of the number of lines is started. The counting of the number of lines is continued after the calculated load value, being not higher than the predetermined high load value, is detected more than once until the calculated load value, being not lower than the predetermined high load value, is again detected and the number of lines obtained by the counting is used as a value representing a variation period. Next, judgement is made as to whether the value obtained by the counting is within a predetermined range (the number of lines being within an audio frequency range) or, if the counted value is within the range, another judgement is made as to whether the value obtained by the counting occupies the variation period during a frame, the same display occurs and for more than a specified period of time and, if so, the driver controlling section 6 receives an instruction so that, when display is made during a subsequent frame, driving order is switched in a manner to correspond to a load variation period or display pattern. The instruction contains the number of the line from which counting is started which represents timing of permuting of driving order, and the number of lines that represents a load variation period or a display pattern, and the judgement may be made at every time of the above judgement or at every time when the judgement for one frame is terminated. The driver controlling section 6 accumulates the instruction in order to permute the order of driving lines during a subsequent frame. If the load variation detecting section 5 instructs a display pattern, the display pattern is indicated by an arrangement of luminance values obtained by converting a calculated load value of each line, based on a threshold value, into binary values with a white level and a black level. Moreover, it is presumed that the number of a line has been added to input display data.

Next, permuting of the driving order to be made by the driver controlling section 6 is explained. In the display in which, the lower luminance, the smaller the driving load and the higher the luminance, the larger the driving load, when a driving horizontal frequency is 65 kHz and in the case of use of a display pattern in which a white and a black appear repeatedly for every two lines, a case where periodic load variation appears for every four lines is described. When each line is driven by a white/black horizontal band display method, a pattern of “white, white, black, black, white, white, black, black, . . . ” is displayed and, therefore, a load varies for every two lines and, as a result, such a ripple as shown in FIG. 5 occurs. At this time point, a load variation period B becomes 16.25 kHz which is within a range of an audio frequency (not higher than 20 kHz) and vibration noise occurring in components exhibiting a piezoelectric effect caused by this ripple is recognized as audible noise. Then, the driver controlling section 6 receives data of the display pattern consisting of “white, white, black, black, white, . . . ” in one load variation period instructed by the load variation detecting section 5 and permutes the order of the driving lines so that the driving is made actually according to a new order of “white, black, white, black, white, . . . ” The permuting of the driving lines is realized by saving a pattern in a form of a table so that the display pattern of “white, white, black, black, white, . . . ” is permuted to the display pattern of “white, black, white, black, . . . ” By making the permute of the driving lines, a load variation period becomes a period for every one line and the ripple occurring in the driving circuit is changed to one shown in FIG. 4. At this time point, the load variation period A is 33 kHz which is outside of the audio frequency range, thus preventing the ripple from being recognized as audible noise.

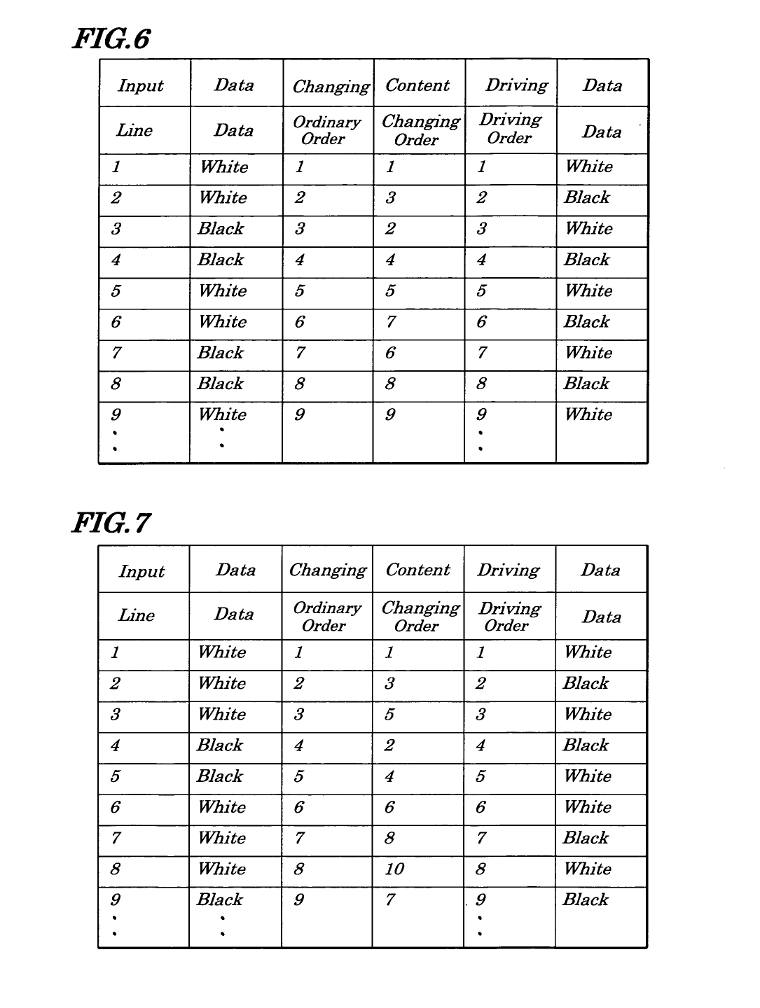

FIG. 6 shows the permuting order of the driving lines at this time point. In the examples of the line 1 to line 5 containing the input display data shown in FIG. 6, the pattern displayed in order of “white, white, black, black, white, . . . ” as a sum total of data in each line is input. This is a display pattern in which audible noise is produced when the pattern is displayed in an ordinary driving order and, therefore, permuting of the driving order is made so that the line 2 is driven third and the line 3 is driven second. This causes the display pattern to be displayed in order of “white, black, white, black, white, . . . ” in each line and, as a result, the load variation period is changed to be outside of the audio frequency range and it is made possible to prevent vibration noise caused by components exhibiting a piezoelectric effect from being recognized as audible noise.

Similarly, as shown in FIG. 7 in the case of a horizontal display consisting of five lines with three lines being white and two lines being black which provides a display pattern consisting of “white, white, white, black, black, white, . . . ” for which load variation period is within the audio frequency range”, by permuting the order of driving the pattern so as to be displayed in order of “white, black, white, black, white, white, . . . ” the load variation period is changed to be outside of the audio frequency range and, as a result, it is made possible to prevent vibration noise caused by load variations occurring in components exhibiting a piezoelectric effect from being recognized as audible noise. In the examples of the line 1 to line 6 containing the input display data shown in FIG. 6, the pattern displayed in order of “white, white, white, black, black, white, . . . ” as a sum total of data in each line is input. This is a display pattern in which audible noise is produced if the pattern is displayed in an ordinary driving order and, therefore, permuting of the driving order is made so that the line 2 is driven third and the line 3 fifth, the line 2 second, and the line 5 fourth. This causes a display pattern for each line to be displayed in order of “white, black, white, black, white, white, . . . ” and the load variation period is changed to be outside of the audio frequency range and, as a result, it is made possible to prevent vibration noise caused by load variations occurring in components exhibiting a piezoelectric effect from being recognized as audible noise. Also, in the case of other display patterns consisting of data input repeatedly and in which load variation period is within an audio frequency and within the frequency range that may cause noise from components exhibiting a piezoelectric effect, by permuting the order of driving lines using the same method as above, it is made possible to prevent the noise from being recognized as audible noise.

In the above example, an instruction for permuting the order of driving lines is provided by using the number of a start line and display pattern, however, the instruction for permuting the order of driving lines can be provided by using the number of the start line and load variation period, that is, the number of lines representing the load variation period. To do this, by storing, in advance, driving order patterns corresponding to the number of lines representing all load variation periods in a form of a table and by searching the table for the driving order pattern corresponding to the number of lines detected by the load variation detecting section 5, the order of driving lines is permuted.

Capacity of the memory section 4 required for permuting of order of driving lines differs depending on a driving order pattern to be permuted and is provided in a manner to satisfy the maximum condition necessary for a pattern to be prepared. Specifically, the memory section 4 has to store display data for a succeeding line while the order of driving the specified number of lines “a” is being permuted and, therefore, the capacity capable of storing the number of lines “a+1” of display data is required. Moreover, it is assumed that the number of a line is added to input display data and the number of the line is sequentially stored in an empty memory for a line. The driver controlling section 6 searches for a plurality of lines of data stored in the memory section 4 by using the number of the line to be driven to read the data. At this time point, judgement is first made as to whether the number of a line of data to be read is the number of a start line to which an instruction for permuting the order is provided and, if the number of the line is a number of the start line, a display pattern that represents a variation period or order changing pattern corresponding to the number of lines is obtained by searching the table and, according to the obtained order pattern, the number of the line following the number of the start line are changed.

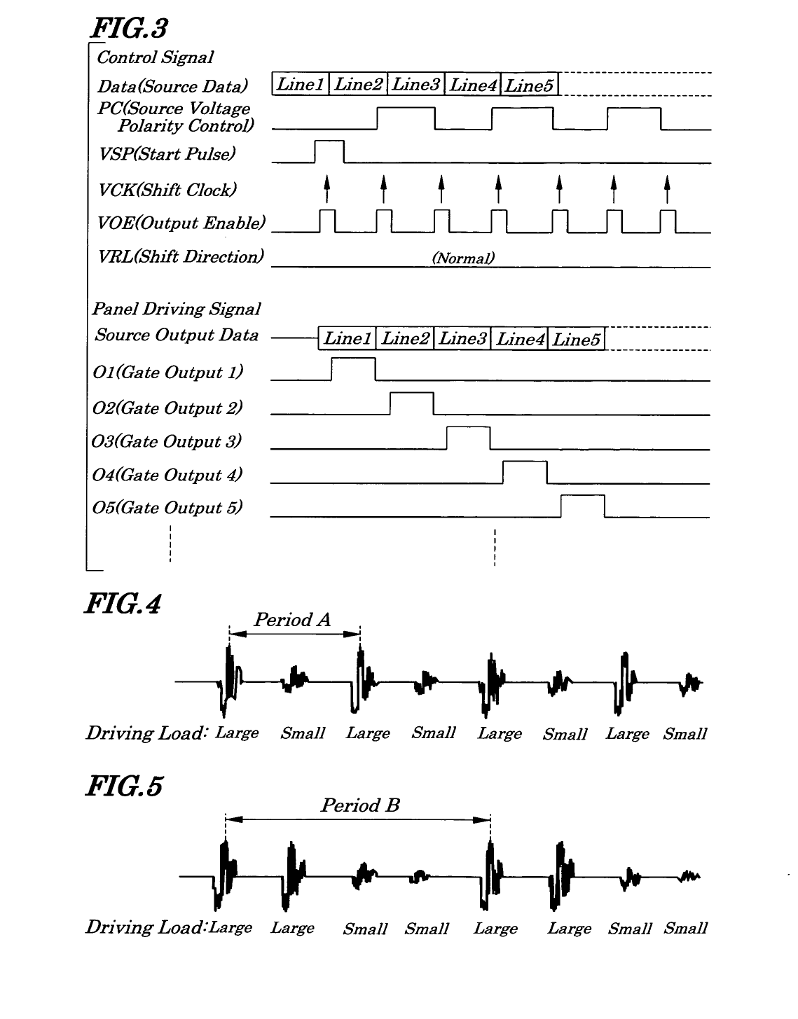

Next, control signals output from the driver controlling section 6 to each driver and used to realize permuting of the described driving order are explained. FIG. 2 shows timing, in the embodiment, of a control signal occurring when order of driving lines is permuted to drive a display panel section in the case where periodical load variations in every four lines appear. FIG. 3 shows timing, in the embodiment, of a control signal occurring when order of driving lines is not permuted and a display panel section is driven in an ordinary order.

When order of driving lines is permuted, as shown in FIG. 2, in the case where periodical load variations in every four lines appear, the driver controlling section 6 first determines the number of the line to be driven and searches for data corresponding to the determined number of the line from the memory section 4 and outputs the searched data to the source driver 2 as source data. In the method of determining the number of a line to be driven, checking is started from the number (01) of the first line occurring during a frame and judgement is made as whether the number of the first line is the number of a start line to which an instruction for permuting order of driving lines is provided by the load variation detecting section 5 and, if the first number is the number of the start line, the number of the line is determined as the number of a line to be driven. If the number of the first line is the number of the start line, as described above, an order permuting pattern is searched for from the table and order of driving lines is permuted according to the searched order pattern to determine the number of the line. The driver controlling section 6 also exercises control so that, by outputting a start pulse (VSP) at a head time during a frame to the gate driver 3 and by outputting, based on a difference between the number of a line to be driven and the number of a line having been driven previous time, a shift direction control signal (VRL) and a plurality of continuous shift clocks (VCK), a shift direction and an amount of shifting of the start pulse are calibrated and source data is output sequentially or in permuted order to lines to be driven (01, 03, 02, 05, 04, in the example shown FIG. 2). At this time point, masking is performed so that the source data is not output while the driving lines are being shifted and an output enable signal (VOE) is output to the gate driver 3 so that source data is output when specified lines are driven after the termination of shifting. Also, the driver controlling section 6, by controlling a voltage polarity controlling signal (PC), in a manner to correspond to driving lines, when polarity control of a driving voltage is necessary as in the case of a liquid crystal device or a like and, by outputting the voltage polarity controlling signal PC to the source driver 2, realizes the same display state as the state in which lines are driven in an ordinary driving order.

The case where lines are driven in an ordinary driving order as shown in FIG. 4 denotes a case where no instruction for permuting order of driving lines is provided by load variation detecting section 5 in a frame during which display is to be made. In this case, the driver controlling section 6 determines the number of a line to be driven and searches for data of the determined number of the line from the memory section 4 to output the data as source data to the source driver 2. However, in the case where lines are driven in an ordinary driving order, no instruction for permuting order of driving lines is provided at the time of determination of the number and, therefore, decision of the number of the first line occurring during a frame is made sequentially from the number (01) of the first line as the number of the line to be driven. The driver controlling section 6 outputs a start pulse (VSP) to the gate driver 3 at a head time during a frame and also a shift direction control signal (VRL) representing a shift direction and a shift clock (VCK). In this case, however, since no instruction for permuting order of driving lines is provided, a difference between the number of a line to be driven and number of a line having been driven previous time is equal to an amount of one shift in a normal direction and a shift direction control signal (VRL) representing a normal shift direction and one shift clock (VCK) are output every time one line is driven. This causes a start pulse to be shifted in a normal direction for every one line and lines to be driven in order of the numbers (01, 02, 03, . . . ) of the line. At this time point, masking is performed so that the source data is not output while the driving lines are being shifted and an output enable signal (VOE) is output to the gate driver 3 so that source data is output when specified lines are driven after the termination of shifting in the same way that described above and also a voltage polarity controlling signal (PC) is controlled, in a manner to correspond to driving lines, when polarity control of a driving voltage is necessary as in the case of a liquid crystal device or a like in the same way that described above.

In the embodiment, a type of feedback control is not exercised in which a variation period of load variations is detected from an actual noise or a voltage ripple to permute order of driving lines, but a type of feed-forward control is exercised in which a variation period of load variations causing nose is detected from input display data to permute order of driving lines. As a result, there is no fear of occurrence of a control hunting phenomenon caused by a deviation in time occurring when order of driving lines in a subsequent frame is permuted according to a result from detection during a present frame. Despite the deviation in time occurring when order of driving lines is permuted in a subsequent frame according to a result from detection during a present frame, since a video or image being displayed during a present frame is very analogous to that displayed during a subsequent frame and since noise is recognized only when the same display patterns appear over a time period of several frames, a high effect of suppressing noise caused by components exhibiting a piezoelectric effect can be achieved. This method of reducing noise has an advantage that adoption of the method is not required in which a load on each pixel that may affect an image quality is reduced by exercising control of frequency components causing audible noise and that there is no need for using components exhibiting no piezoelectric effect which present a problem in terms of an mounting area and/or costs.

### Second Embodiment

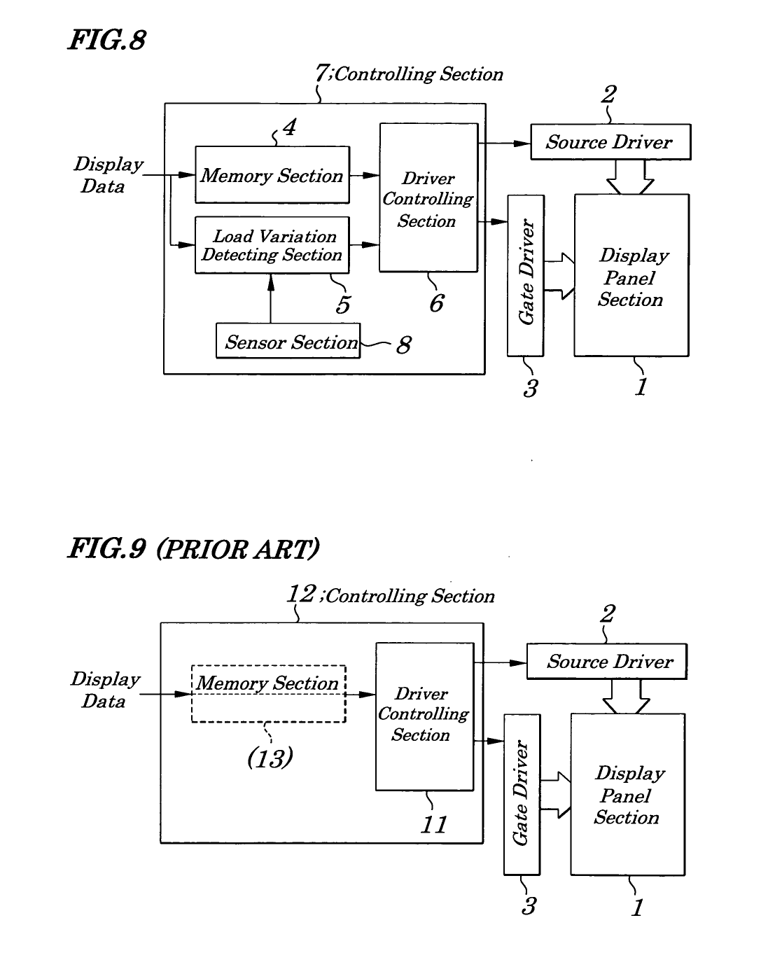

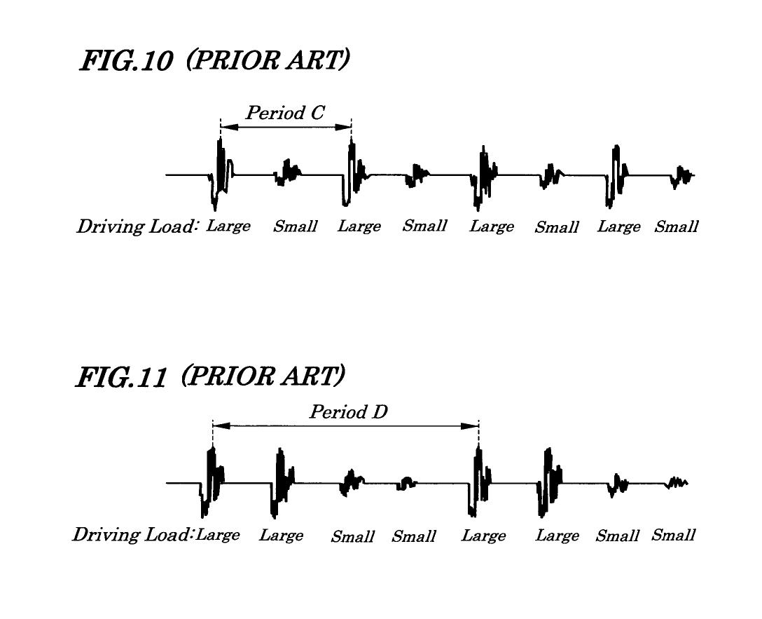

The second embodiment is achieved by using a method (2) described above. Electrical configurations of a display device (liquid crystal display device) according to the second embodiment are described by referring to FIG. 8. The electrical configurations of the display device according to the second embodiment differ greatly from those employed in the first embodiment in configurations of the load variation detecting section 5. Configurations other than those of a load variation detecting section 5 are approximately the same as those used in the first embodiment and can be easily designed by analogy and descriptions of them are omitted accordingly.

First, configurations of the load variation detecting section 5 of the second embodiment are explained. The load variation detecting section 5 is configured to receive a signal output from a sensor section 8 to detect actual audible noise. An acoustic sensor with, for example, a small-sized microphone or a like or vibration sensor can be also employed in the sensor section 8. The vibration sensor is so configured that vibration is detected, based on a relative movement between a permanent magnet supported, in a manner to absorb mechanical impact, via an elastic member such as a spring-mass system, elastic resin, or a like and a conductor that moves together with a vibrating portion, by an induced current or eddy current flowing through a conductor. Sensitivity of the sensor section 8 is calibrated in advance based on a frequency characteristic and amplification of an amplifier or a like so as to detect a vibration with a level of being recognized as audible noise. The sensor section 8 is placed in the vicinity of components exhibiting a piezoelectric effect. The load variation detecting section 5 measures a frequency or period of the audible noise detected by the sensor section 8 and outputs an instruction for permuting order of driving lines to a driver controlling section 6 one by one or collectively. The instruction for permuting order of driving lines is associated, by the load variation detecting section 5 or driver controlling section 6, with a start line representing timing with which the order of driving lines is permuted. An example of a method for measuring a frequency or period of audible noise includes a method in which the frequency or period is calculated by counting a clock pulse occurring between peaks of the audible noise. By measuring a pulse having the same period as a line period or the number of input display data, instead of a clock pulse, the number of lines representing the load variation period can be obtained.

Configurations in which an instruction for permuting the order of the driving lines is associated with a start line by the load variation detecting section 5 are determined by considering a timing difference based on the number obtained by subtracting the number of lines accumulated by a memory section 4 from the numbers of the lines indicated in input display data. Here, if a value of an original number is negative, the number of a final number is used as a start line number and, therefore, a number obtained by adding the number of the end line to the negative value is used. Moreover, configurations in which the instruction is associated with a start line by the driver controlling section 6 are determined by the method in which the load variation detecting section 5 outputs an instruction for permuting the order of the driving lines to the driver controlling section 6 one by one every time a period of audible noise is detected and the driver controlling section 6 traces the number of lines in reverse order from the number of the line having been driven. The number of lines, though being able to be obtained by counting on the load variation detecting section 5 side, also can be calculated by dividing the period of the audible noise by a line period and, therefore, the number of lines may be calculated by doing division on the load variation detecting section 5 side or on the driver controlling section 6 side.

Next, functions of the driver controlling section 6 being different from those provided in the first embodiment are described. A display device according to the first embodiment is so configured that the number of the start line for which order of driving lines is to be permuted, display pattern, or the number of lines are received as an instruction for permuting order of driving lines and are held until a subsequent frame starts during which the order of driving lines is permuted. A display device according to the second embodiment is so configured that the number of a start line for which the order of the driving lines is to be permuted and a variation period or the number of lines are received and are held until a subsequent frame starts during which the order of driving lines is to be permuted or that a variation period, the number of lines and timing of detecting the variation period and the number of lines are received, and the number of the start line for which the order of driving lines is to be permuted is associated with the variation period and the number of lines based on the timing and the associated state is held until a subsequent frame starts during which the order of driving lines is permuted.

In the second embodiment, a type of feedback control is exercised in which a load variation period is detected from an actual noise to permute order of driving lines and, therefore, there is a concern of occurrence of a hunting phenomenon caused by a deviation in time occurring when the order of driving lines is to be permuted during a subsequent frame according to a result from the detection during a present frame. That is, if, by using a result from the detection of the audible noise at time of displaying during one frame 1, order of driving lines during a subsequent frame 2 is permuted, the occurrence of the audible noise can be avoided during the subsequent frame 2. Therefore, since no audible noise is detected at time of displaying during the frame 2, at the time of displaying during a frame 3 subsequent to the frame 2, the order of driving lines is not permuted. However, a state occurring during the frame 3 is very analogous to that occurring during the frame 2 and there is, therefore, a high possibility that a display pattern exists in which load variations causing audible noise readily to occur during the frame 3 as in the case of the frame 2. Despite this state, order of driving lines is not permuted during the frame 3 and, therefore, a possibility exists that the audible noise is produced at time of displaying during the frame 3. Thus, if noise is detected at time of displaying during the frame 3, order of driving lines is permuted in the subsequent frame 4, as a result, causing a control hunting phenomenon. This means that the effect of preventing the occurrence of the audible noise is reduced by half.

To solve this problem, the driver controlling section 6 of the second embodiment, when receiving an instruction for permuting order of driving lines from the load variation detecting section 5, permutes the order of driving lines at time of displaying from a subsequent frame over a period of time of a plurality of frames so that the same order patterns are displayed. If an instruction for permuting order of driving lines is provided by the load variation detecting section 5 during this period of time, no effect of suppressing the audible noise by permuting order of driving lines is expected and, therefore, permuting of order of driving lines during a subsequent frame is stopped and, if an instruction for permuting order of driving lines is provided by the load variation detecting section 5 thereafter, the order of driving lines is again permuted during a plurality of frames by using the same order pattern. This enables prevention of the control hunting phenomenon as described above. Thus, the same effect obtained in the first embodiment can be achieved also in the second embodiment.

### Third Embodiment

Next, the third embodiment will be explained which is realized according to a method (3) described above. Electrical configurations of a display device are similar to those adopted in the second embodiment. Electrical configurations of the display device according to the third embodiment are described by referring to FIG. 8. The electrical configurations of the display device of the third embodiment differ greatly from those employed in the second embodiment in configurations of the load variation detecting section 5. Configurations other than those of a load variation detecting section 5 are approximately the same as those used in the second embodiment and can be easily designed by analogy and their descriptions are omitted accordingly.

First, configurations of the load variation detecting section 5 of the third embodiment are explained. The load variation detecting section 5 has a sensor section 8 to detect an amplitude of a voltage ripple and a frequency. An amplification circuit coupled to a capacitor that interrupts a direct current and detects only alternating current components can be connected to a resistor used to detect a load voltage in the sensor section 8. The load variation detecting section 5 measures an amplitude of the load variation based on the power ripple detected by the sensor section 8 and a variation period and judges, if the load variation has peak values greater than a specified magnitude and a period between the peak values is found to be within an audio frequency range, that audible noise occurs from components exhibiting a piezoelectric effect and outputs an instruction for permuting order of driving lines to a driver controlling section 6 one by one or collectively at time of termination of displaying during one frame and in response to a request from the driver controlling section 6. The instruction for permuting the order of the driving lines is associated with a start line to be used when the order of the driving lines is permuted. Configurations in which the detected variation period is associated with a start line representing timing of permuting the order of the driving lines and in which the number of lines are detected or calculated are the same as those in the second embodiment.

In the third embodiment as in the case of the second embodiment, a type of feedback control is exercised in which a load variation period is detected from an actual audible noise to permute order of driving lines and, therefore, there is a possibility of occurrence of the control hunting phenomenon caused by a deviation in time occurring when the order of the driving lines is to be permuted during a subsequent frame according to a result from the detection during a present frame.

To prevent the effect of avoiding occurrence of audible noise from being reduced to one-half, the driver controlling section 6 of the third embodiment, when receiving an instruction for permuting order of driving lines from the load variation detecting section 5, permutes the order of the driving lines at time of displaying during a subsequent frame over a plurality of frames so that the same order patterns are displayed. If an instruction for permuting the order of the driving lines is provided by the load variation detecting section 5 during this period of time, no effect of suppressing audible noise by permuting the order of the driving lines is expected and, therefore, permuting of the order of the driving lines at time of displaying during a subsequent frame is stopped and, when an instruction for permuting the order of the driving lines is provided by the load variation detecting section 5 thereafter, the order of the driving lines is again permuted during a plurality of frames by using the same order pattern. This enables prevention of the hunting phenomenon described above. Thus, the same effect obtained in the first embodiment can be also achieved in the third embodiment.

It is apparent that the present invention is not limited to the above embodiments but may be changed and modified without departing from the scope and the spirit of the invention. For example, in the above embodiments, a liquid crystal display panel section is described as an example of a display device. However, the present invention can be applied to a display device using other display panel section such as a plasma display panel section, an organic electro-luminescent display panel section, or a like.

The present invention can be suitably employed for a large-sized flat-type display device to be used in a pavilion such as an art museum, museum, or a like and in a place where silence is required such as a hospital or a like.

What is claimed is:

1. A display device comprising:
a display panel section having a plurality of scanning lines;
a driver to drive said display panel section for every scanning line;
at least one piezoelectric component exhibiting a piezoelectric effect;
a detecting unit to detect, predict or estimate directly or indirectly a variation period and timing of occurrence of a first load variation causing occurrence of audible noise from said at least one piezoelectric component; and
a driver controlling unit to output a control signal to said driver, the control signal used to permute order of driving the plurality of the scanning lines for another order of driving the plurality of the scanning lines which gives a variation period of a second load variation that prevents occurrence of audible noise caused by said at least one piezoelectric component, according to the detected, the predicted or the estimated variation period of the first load variation.

2. The display device according to claim 1, wherein said detecting unit totalizes input display data for every said scanning line, and detects, predicts or estimates directly or indirectly the variation period and the timing of occurrence of the first load variation, based on a variation amount and the variation period of the total value of the input display data for every said scanning line.

3. The display device according to claim 1, wherein said detecting unit detects the audible noise caused by said at least one piezoelectric component, and detects, predicts or estimates directly or indirectly the variation period and the timing of occurrence of the first load variation, based on the detected audible noise.

4. The display device according to claim 1, wherein said detecting unit measures an amount of load variation and a variation period, and detects, predicts or estimates directly or indirectly the variation period and the timing of occurrence of the first load variation, based on the measured amount of the load variation and the measured variation period.

5. The display device according to claim 2, wherein said detecting unit detects binary luminance values as the input display data for every said scanning line.

6. The display device according to claim 2, wherein said detecting unit detects a display pattern made up of binary luminance values, the variation period of the first load variation represented by the display pattern made up of binary luminance values.

7. The display device according to claim 2, wherein said detecting unit detects an individual line number of a scanning line associated with the input display data, the timing of occurrence of the first load variation represented by the detected line number.

8. The display device according to claim 1, wherein said detecting unit detects or calculates a count of the scanning lines, the variation period of the first load variation represented by the detected or calculated count of the scanning lines.

9. The display device according to claim 1, wherein said driver controlling unit calculates the count of the scanning lines based on the variation period of the first load variation detected, predicts or estimates directly or indirectly by said detecting unit.

10. The display device according to claim 1, wherein said driver controlling unit has a table storing, in advance, driving order patterns for permuting the scanning lines, corresponding to the variation period of the first load variation.

11. The display device according to claim 10, wherein said driver controlling unit searches said table based on the detected, the predicted or the estimated variation period of the first load variation, and as a result of the search, permutes order of driving the plurality of the scanning lines for another order of driving the plurality of the scanning lines which provides the variation period of the second load variation that prevents occurrence of audible noise caused by said at least one piezoelectric component.

12. The display device according to claim 1, wherein said driver has a shift register being able to shift driving order of the scanning lines forward or backward, and wherein said driver controlling unit outputs a first control signal to perform masking of an output of display data according to order of driving the scanning lines and a second control signal to indicate to shift driving order of the scanning lines forward or backward.

13. The display device according to claim 1, wherein said driver controlling unit permutes order of driving the scanning lines according to order of driving the scanning lines by using a memory section capable of storing the input display data for the plurality of the scanning lines.

14. A display device comprising:
a display panel section having a plurality of scanning lines;
a driving means to drive said display panel section for every scanning line;
at least one piezoelectric component exhibiting a piezoelectric effect;
a detecting means to detect, predict or estimate directly or indirectly a variation period and timing of occurrence of a first load variation causing occurrence of audible noise from said at least one piezoelectric component; and
a drive controlling means to output a control signal to said driving means, the control signal used to permute order of driving the plurality of the scanning lines for another order of driving the plurality of the scanning lines which gives a variation period of a second load variation that prevents occurrence of audible noise caused by said at least one piezoelectric component, according to the detected, the predicted or the estimated variation period of the first load variation.

15. The display device according to claim 14, wherein said detecting means totalizes input display data for every said scanning line, and detects, predicts or estimates directly or indirectly the variation period and the timing of occurrence of the first load variation, based on a variation amount and the variation period of the total value of the input display data for every said scanning line.

16. The display device according to claim 14, wherein said detecting means detects the audible noise caused by said at least one piezoelectric component, and detects, predicts or estimates directly or indirectly the variation period and the timing of occurrence of the first load variation, based on the detected audible noise.

17. The display device according to claim 14, wherein said detecting means measures an amount of load variation and a variation period, and detects, predicts or estimates directly or indirectly the variation period and the timing of occurrence of the first load variation, based on the measured amount of the load variation and the measured variation period.

18. The display device according to claim 15, wherein said detecting means detects binary luminance values as the input display data for every said scanning line.

19. The display device according to claim 15, wherein said detecting means detects a display pattern made up of binary luminance values, the variation period of the first load variation represented by the display pattern made up of binary luminance values.

20. The display device according to claim 15, wherein said detecting means detects an individual line number of a scanning line associated with the input display data, the timing of occurrence of the first load variation represented by the detected line number.

21. The display device according to claim 14, wherein said detecting means detects or calculates a count of the scanning lines, the variation period of the first load variation represented by the detected or calculated count of the scanning lines.

22. The display device according to claim 14, wherein said drive controlling means calculates the count of the scanning lines based on the variation period of the first load variation detected, predicts or estimates directly or indirectly by said detecting means.

23. The display device according to claim 14, wherein said drive controlling means has a table storing, in advance, driving order patterns for permuting the scanning lines, corresponding to the variation period of the first load variation.

24. The display device according to claim 23, wherein said drive controlling means searches said table based on the detected, the predicted or the estimated variation period of the first load variation, and as a result of the search, permutes order of driving the plurality of the scanning lines for another order of driving the plurality of the scanning lines which provides the variation period of the second load variation that prevents occurrence of audible noise caused by said at least one piezoelectric component.

25. The display device according to claim 14, wherein said driving means has a shift register being able to shift driving order of the scanning lines forward or backward, and wherein said drive controlling means outputs a first control signal to perform masking of an output of display data according to order of driving the scanning lines and a second control signal to indicate to shift driving order of the scanning lines forward or backward.

26. The display device according to claim 14, wherein said drive controlling means permutes order of driving the scanning lines according to order of driving the scanning lines by using a memory section capable of storing the input display data for the plurality of the scanning lines.
